(19) United States
(12) Patent Application Publication
(10) Pub. No.: US 2010/0146273 A1
(43) Pub. Date: Jun. 10, 2010

(54) METHOD FOR PASSIVE RFID SECURITY ACCORDING TO SECURITY MODE

(75) Inventors: You Sung KANG, Daejeon (KR); Doo Ho CHOI, Cheonan-si (KR); Yong-Je CHOI, Daejeon (KR); Kyo Il CHUNG, Daejeon (KR); Hyunsook CHO, Daejeon (KR); Heyung Sub LEE, Daejeon (KR); Sang Yeoun LEE, Daejeon (KR); Kang Bok LEE, Daejeon (KR); Dong-Beom SHIN, Daejeon (KR); Jae-young JUNG, Daejeon (KR); Cheol Sig PYO, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/566,982

(22) Filed: Sep. 25, 2009

(30) Foreign Application Priority Data
Dec. 4, 2008 (KR) 10-2008-0122747
Apr. 2, 2009 (KR) 10-2009-0028572

(51) Int. Cl. H04L 9/32

(52) U.S. Cl. 713/168

(57) ABSTRACT

Provided are a method for passive radio frequency identification (RFID) security according to a security mode. An RFID tag transmits its own current security mode to a reader and the reader drives a security protocol depending on the current security mode of the RFID tag. Also, the reader grasps the ability of the tag and then the reader drive a protocol suitable for the ability through the security mode.

### CROSS-REFERENCE TO RELATED APPLICATION

This application claims priority to and the benefit of Korean Patent Application Nos. 10-2008-0122747 and 10-2009-0028572 filed in the Korean Intellectual Property Office on Dec. 4, 2008 and Apr. 2, 2009, the entire contents of which are incorporated herein by reference.

### BACKGROUND OF THE INVENTION

(a) Field of the Invention

The present invention relates to a method for passive RFID security according to a security mode.

(b) Description of the Related Art

With development a semiconductor technology, even in a passive radio frequency identification (RFID) tag, a condition that can drive an advanced encryption standard (ASE) encryption algorithm is created. This means that data can be encrypted from application of a security technology. That is, when data can be encrypted in the passive RFID tag that does not have its own power supply, and thus should be supplied with power from a reader, various security protocols can be implemented.

In addition, the passive RFID tag may be set in various security modes depending on security strength or a security function. In this case, the reader verifies a current security mode of the tag and performs the security function suitable for the current security mode to satisfy the security strength that the corresponding RFID system requires.

That is, in the related art, the passive RFID tag does not utilize the encryption algorithm and the security mode indicating the security strength, such that flexible utilization is difficult.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a security method between an RFID tag and an RFID reader in which the RFID reader verifies a security mode of the RFID tag and performs an authentication protocol operation or a data protection protocol operation depending on the security mode.

An exemplary embodiment of the present invention provides a method for passive RFID security according to a security mode, that includes: requesting a second random number by using a first random number when the first random number, protocol control information, extended protocol control information, and unique item identification information are received from a tag; requesting a security parameter by transmitting a message including the second random number when the second random number is received from the tag; requesting an authentication result of encrypted data to an authentication server when the encrypted data is received from the tag; and authenticating the tag in accordance with the authentication result of the encrypted data received from the authentication server.

Another embodiment of the present invention provides a security method that includes: transmitting protocol control information, extended protocol control information, and unique item identification information to a reader when a message using a first random number as a parameter is received from the reader; creating and transmitting a second random number to the reader when a random number request message using the first random number as the parameter is received; and transmitting encrypted authentication data and an encrypted random number to the reader when an authentication data request message using the second random number and the random number arbitrarily created by the reader as the parameter is received.

### BRIEF DESCRIPTION OF THE DRAWINGS

FIG. 1 is an exemplary diagram of a data format indicating a security mode according to an embodiment of the present invention.

FIG. 2 is an exemplary diagram of security vulnerability for each application service according to an embodiment of the present invention.

FIG. 3 is a flowchart illustrating an operation of a tag authentication mode according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

In the specification, unless explicitly described to the contrary, the word “comprise” and variations such as “comprises” or “comprising” will be understood to imply the inclusion of stated elements but not the exclusion of any other elements.

When an article attached with a passive RFID tag requires high security strength, and thus security functions such as authentication of an RFID tag, protection of an RFID tag data security, the guarantee of RFID tag integrity, etc. are required, an RFID tag that has a calculation ability to support the security functions and can set a security mode suitable for the calculation ability should be used. If an application requires only the authentication of the RFID tag without the protection of the RFID tag data, only calculation suitable for the authentication is processed and the corresponding security mode is set.

That is, in the embodiment of the present invention, the security strength that the application requires is set to the security mode, and the RFID tag and the RFID reader operate depending on the corresponding security mode to provide a security technology to provide a security service that the application requires and perform an optimized calculation. In the embodiment of the present invention, it is configured to have compatibility with the ISO/IEC 18000-6 Type C standard, which is a representative standard of the passive RFID tag, but is not limited thereto. Hereinafter, this will be described with reference to the accompanying drawings.

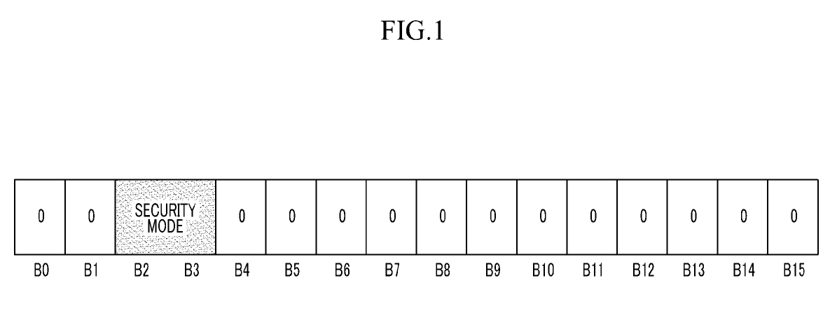

FIG. 1 is an exemplary diagram of a data format indicating a security mode according to an embodiment of the present invention.

As shown in FIG. 1, a 16-bit extended protocol control (XPC) data structure may include a security mode indicator. The security mode indicator is composed of 2 bits, and the bits may be included in extra bits of the extended protocol control.

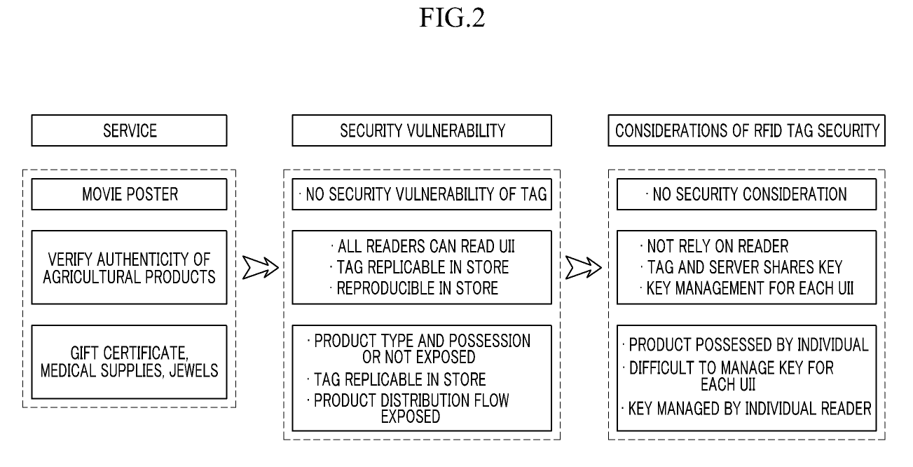

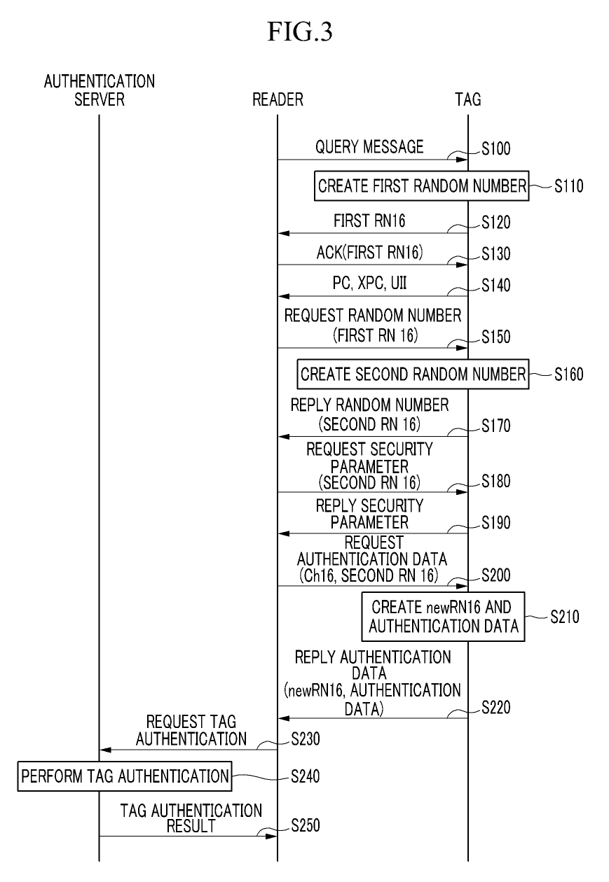

In the embodiment of the present invention, since the 2-bit security mode indicator is used, a total of four security modes can be indicated. For this, a utilization example and a security mode field for each security mode are shown in Table 1. While describing Table 1, a representative service for each application service and security considerations for the representative service, and an operation procedure of a tag authentication mode, will be described with reference to FIGS. 2 and 3.

TABLE 1

| Security | | | Utilization | Security |
|---|---|---|---|---|
| mode | Characteristics | Effects | examples | mode field |
| Mode 1 | UII exposure | Access password exposable | Simple article | 00 |
| (Non-security | 18000-6 Type C | Product type exposable | recognized | |
| mode) | | Replication tag appearable | | |
| | | Tag/reader communication | | |
| | | data interceptible | | |
| Mode 2 | UII exposure | Product moving path | Authenticity of | 01 |
| (tag | Server authenticates tag | trackable | agricultural | |
| authentication | Tag and server shares key | Tag/reader communication | products inspected | |
| mode) | Authentication protocol | data interceptible | When verification of | |
| | | Tag authenticity verified | authenticity is required | |
| | | Prevention of replication | | |
| | | tag (Malicious replication of | | |
| | | reader impossible) | | |
| Mode 3 | UII protection | Prevention of replication | Mobile RFID | 10 |
| (Group key | Tag/reader communication | tag (Malicious replication of | When individuals | |
| management | data protection | reader possible) | ownership transfer | |
| mode) | Management of | Tracking prevention of | is required | |
| | group key in reader | product moving path | | |
| | Data protection protocol | Tag/reader communication | | |
| | | data protection | | |
| | | Protection of owner privacy | | |
| Mode 4 | UII protection | Prevention of replication | Authenticity of | 11 |
| (Individual key | Tag/reader communication | tag (Malicious tag | agricultural | |
| management | data protection | replication of reader | products inspected | |
| mode) | Key management for | impossible) | Mobile RFID | |
| | each UII | Tracking prevention of | When authenticity | |
| | | product moving path | verification/owner- | |
| | | Tag/reader communication | ship transfer is | |
| | | data protection | required | |
| | | Protection of owner privacy | | |

First, as shown in Table 1, Mode 1 having a security mode value of 00 is also referred to as a non-security mode, and means a mode that operates in a general ISO/IEC 18000-6 Type C standard without a security function. In this case, the RFID tag just transmits ID information of a tag to a reader and the reader collects information on an article from a separate server through a backend network.

A representative service of Mode 1 is a movie poster service, and services including the movie poster service will be described with reference to FIG. 2. FIG. 2 is an exemplary diagram of a representative service for each application service, and security considerations for the service according to an embodiment of the present invention.

As shown in FIG. 2, when the RFID tag is attached to a movie poster, a user can read the RFID tag and collect information related to a movie from a backend server. In this service, even though the ID information of the RFID tag may be exposed, authentication and data protection are not required.

Next, Mode 2 having a security mode value of 01 of Table 1 is also referred to as a tag authentication mode, and a representative service of this mode is an authenticity inspection service of agricultural products such as Korean beef cattle. An operation method of Mode 2 will be described below. A producer of the Korean beef cattle attaches the RFID tag to the Korean beef cattle, sets the security mode value to 01, and sets a secret key to the RFID tag. In addition, the producer of the Korean beef cattle stores the secret key of the corresponding RFID tag in a safe authentication server.

A consumer who drops in to a store of the Korean beef cattle wants to verify the authenticity or not of the Korean beef cattle through the RFID tag attached to the arranged Korean beef cattle. At this time, a reader that reads the RFID tag to inspect the authenticity may be a reader of the store or a portable reader of the consumer. In this case, when the secret key of the RFID tag is transmitted to the reader of the store or the reader of the consumer, a risk in which the replicated RFID tag can be distributed by a malicious store or consumer exists.

Therefore, in Mode 2, the reader should receive only an authentication result from the authentication server. Mode 2 according to the embodiment of the present invention is configured to have compatibility with the ISO/IEC 18000-6 Type C standard. It is assumed that the reader can communicate with the authentication server through a safe channel, and it is assumed that the tag has a security parameter (SecParam).

The security parameter is a structure including information related to a used encryption algorithm, and in the embodiment of the present invention, a description of a detailed shape will be omitted. It is assumed that the RFID tag according to the embodiment of the present invention stores the secret key therein, and it is assumed that the reader does not know the secret key and only the authentication server has secret key information of the tag. An operation procedure of Mode 2 will be described with reference to FIG. 3.

FIG. 3 is a flowchart illustrating an operation of a tag authentication mode according to an embodiment of the present invention.

As shown in FIG. 3, the reader transmits a query message to the tag (S100). At this time, parameters (i.e., query, Query_Adjust, Query_Rep, etc.) transmitted while being included in the query message are commands already defined in the standard, and in the embodiment of the present invention, a detailed description thereof will be omitted. The tag that receives the query message creates a random number (S110) and returns a first random number RN16 (S120). Herein, the created random number is 16 bits, and for convenience of description, the random number is represented by RN16.

The reader that receives the first RN16 from the tag notifies that it has received the random number and transmits an acknowledge (ACK) message to the tag in order to receive protocol control (PC) information, extended protocol control (XPC) information, and unique item identification (UII) information from the tag (S130). In this case, the tag that receives the ACK message transmits a message including its protocol control, extended protocol control, and unique item identification information to the reader (S140). Herein, the protocol control, the extended protocol control, and the unique item identification have already been known, and in the embodiment of the present invention, a detailed description thereof will be omitted.

The reader that receives the protocol control, extended protocol control, and unique item identification information transmits a command of a random number request Req_RN that requests a new random number to the tag (S150), and has the first RN16 that is the random number received at step S110 as a parameter. The reason for including the random number as the parameter, as a kind of tag address or session ID concept, is, even though a plurality of tags receive the random number request message, to allow only the tag transmitting the first random number RN16 at step S110 to grasp that the received message is a message therefor.

The tag that receives the random number request message creates a random number to be newly used and returns the random number to the reader (S160 and S170). At this time, the newly created random number is also 16 bits, and is referred to as a second RN16 or a handle.

Next, since a currently supported security mode is indicated in the extended protocol control that the tag transmits to the reader at step S140, the reader performs an operation in a tag authentication mode at steps S180 to S250. That is, as shown in FIG. 1, when a binary number “01” expressing a security mode by 2 bits is indicated in a security mode field having an extended protocol control data structure of a total of 16 bits, the reader performs the operation in the tag authentication mode of steps S180 to S250.

First, the reader transmits a security parameter request message Get_SecParam, which is a command for requesting a security parameter, to the tag (S180). At this time, the reader transmits the security parameter request message that includes the handle which is the second RN16 received from the tag at step S170 at the time of transmitting the security parameter request message. Since the reader does not know a secret key of the tag, the reader transmits data in the form of plain text at all times. The tag that receives the security parameter request message from the reader returns the security parameter (S190).

The reader transmits a command of an encryption data request Req_Auth to the tag in order to acquire encryption data Auth_data encrypting the data (S200). This command has Ch16 which is a random number of 16 bits that the reader creates for challenge and the handle that is the second RN16 received at step S170 as the parameter. The tag that receives the encryption data request command creates newRN16 that is a new random number in order to create the encryption data, creates authentication data by mixing (XOR) the newRN16 with the Ch16 received from the reader, and encrypts the newRN16 and the authentication data (S210).

A session key used for the encryption is created from the secret key K that the tag incorporates and the first RN16 created at step S110. Various algorithms may be used with respect to a method for creating the session key and in the embodiment of the present invention, so a detailed method is not described. Thereafter, the tag returns the encrypted new RN16 and authentication data that are included in the parameter to the reader (S220). At this time, formats of a command/response message with respect to the security parameter request and the authentication data request are shown in Tables 2 to 5.

TABLE 2

| | | Random | |
|---|---|---|---|
| | Command | number (RN) | CRC-16 |
| Size (#of bits) | 16 | 16 | 16 |
| Description | 0xE101 | handle | |

TABLE 3

| | | Security | | |
|---|---|---|---|---|
| | | parameter | Random | |
| | Header | (SecParam) | number (RN) | CRC-16 |
| Size (#of bits) | 1 | 16 | 16 | 16 |
| Description | 0 or 1 | SecParam | handle | |

TABLE 4

| | | | Random | |
|---|---|---|---|---|
| | Command | Challenge | number (RN) | CRC-16 |
| Size (#of bits) | 16 | 16 | 16 | 16 |
| Description | 0xE104 | Ch16 | handle | |

TABLE 5

| | | Random | Authentication | Random | |
|---|---|---|---|---|---|
| | | number | data | number | |
| | Command | (RN) | (Auth_data) | (RN) | CRC-16 |
| Size (#of | 16 | 16 | 16 | 16 | 16 |
| bits) | | | | | |
| Description | 0xE104 | newRN16 | Ch16 [symbol] | handle | |
| | | | newRN16 | | |

A command code shown in Tables 2 to 5 is a value as an example, and is one of values in a standard reserved region but is not limited thereto.

Table 2 shows the security parameter request message, which is transmitted from the reader to the tag through step S180, and Table 3 shows a replay to the security parameter request message, which is transmitted from the tag to the reader through step S190. Table 4 shows an authentication data request, which is transmitted from the reader to the tag through step S200, and Table 5 shows a reply to the authentication data request, which is transmitted from the tag to the reader through step S220. At this time, the random number and the authentication data of Table 5 are encrypted, and the other values are transmitted in the form of the plain text.

Continuously referring to FIG. 3, the reader that receives even the authentication data terminates communication with the tag and verifies the values transmitted from the tag to determine the authenticity through communication with the authentication server. That is, the reader transmits a message of a tag authentication request Req_Verify to the authentication server (S230). At this time, parameters included in the message include the UII of the tag, the first RN16, the security parameter, the Ch16, and the encrypted newRN16 and authentication data received at step S220.

The authentication server authenticates the tag on the basis of the message received from the reader (S240). First, the authentication server searches the secret key K related to the UII and creates the session key from the first RN16 and the K. Various algorithms may be used with respect to a method for creating the session key, and in the embodiment of the present invention, an example in which the tag and the reader use the same algorithm will be described. However, the present invention is not limited thereto. After the authentication server creates the session key, the authentication server decrypts the encrypted newRN16 by using the session key to find a newRN16.

The authentication data is acquired by calculating (XOR) the Ch16 and the found newRN16. The authentication server compares the authentication data value received from the reader with an authentication data value acquired by itself. As the comparison result, if the two values are equal to each other, it is determined that the authentication has succeeded, and if the two values are different from each other, it is determined that the authentication has failed. In addition, the result thereof is returned to the reader (S250). Through the procedure, the operation of the tag authentication mode is performed.

Next, Mode 3 having a security mode value of 10 of Table 1 is also referred to as a group key management mode, and a representative service of this mode is an individual possession management service utilizing a mobile RFID technology. When an individual purchases a product attached with an RFID tag and possesses the product, the possessor sets a security mode value to a binary number “10” while directly inputting a secret key in the RFID tag.

A primary characteristic of this mode is that a UII of an individually possessed RFID tag is encrypted and transmitted. Further, since the key is managed by the individual, the keys are managed by a group key. Herein, in the management by the group key, since, in Mode 3, a protocol in which the UII can be known only when the secret key is known, the possessor should know secret keys of all his/her own tags in order to utilize information on the RFID tag. However, since the possessor is largely burdened with key management when the possessor individually manages the secret keys of all the tags without knowing the UII, the possessor recognizes all his/her own tags as one group and manages the tags with one group key.

Lastly, Mode 4 having a security mode value of 11 of Table 1 is referred to as an individual key management mode, and has both the characteristics of the tag authentication mode of Mode 2 and the characteristics of the key management mode of Mode 3. Mode 4 can be utilized for all services requiring RFID tag authentication and data protection.

In Mode 4, the RFID tag encrypts and transmits its own UII to the reader, and also encrypts and transmits data stored in the RFDI tag. At this time, the secret keys used for encryption are differently used for each RFID tag. In this case, since the reader uses each RFID tag secret key, the security is enhanced. Although a detailed protocol for Mode 2 has been described in detail with reference to FIG. 3 in the embodiment of the present invention, a description of detailed protocols for Modes 3 and 4 will be omitted.

According to an embodiment of the present invention, since an RFID tag transmits its own current security mode to a reader, the reader can drive a security protocol depending on the current security mode of the RFID tag, and since the reader can grasp the ability of the tag through the security mode, the reader can drive a protocol suitable for the ability.

Further, even when a plurality of tags exist, since the reader dos not need to continuously maintain a session after terminating communications with the tags, it is possible to reduce a communication burden between the reader and an authentication server.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A security method, comprising:
requesting a second random number by using a first random number when the first random number, protocol control information, extended protocol control information, and unique item identification information are received from a tag;
requesting a security parameter by transmitting a message including the second random number when the second random number is received from the tag;
requesting an authentication result of encrypted data to an authentication server when the encrypted data is received from the tag; and
authenticating the tag in accordance with the authentication result of the encrypted data received from the authentication server.

2. The method of claim 1, wherein
requesting the authentication result includes:
requesting the encrypted data to the tag by using the second random number and a random number arbitrarily created by a reader as parameters when the security parameter is received;
receiving the encrypted data and an encrypted random number used for creating the encrypted data from the tag; and
requesting an authentication result of the encrypted authentication data including the encrypted random number, the random number arbitrarily created by the reader, and the encrypted authentication data, the unique item identification information, and the first random number to the authentication server.

3. The method of claim 2, further including:
verifying, by the authentication server, a secret key corresponding to the unique item identification information in the authentication server;
creating, by the authentication server, a session key by using the first random number and the secret key;
acquiring, by the authentication server, a random number by decrypting the encrypted random number by using the session key;
acquiring, by the authentication server, encrypted authentication data by using the random number arbitrarily created by the reader and the decrypted random number; and
creating and transmitting, by the authentication server, the authentication result by comparing the received encrypted authentication data with the acquired encrypted authentication data.

4. The method of claim 1, wherein
the extended protocol control information includes a security mode indicator.

5. A security method, comprising:
transmitting protocol control information, extended protocol control information, and unique item identification information to a reader when a message using a first random number as a parameter is received from the reader;
creating and transmitting a second random number to the reader when a random number request message using the first random number as the parameter is received; and
transmitting encrypted authentication data and an encrypted random number to the reader when an authentication data request message using the second random number and the random number arbitrarily created by the reader as parameters is received.

6. The method of claim 5, wherein
transmitting the encrypted random number includes:
receiving the authentication data request message using the random number arbitrarily created by the reader as the parameter;
creating the encrypted random number;
creating authentication data by using the random number arbitrarily created and transmitted by the reader and the random number and creating the encrypted authentication data by encrypting the authentication data; and
transmitting the encrypted data and the encrypted random number to the reader.

7. The method of claim 5, wherein
the extended protocol control information includes a security mode indicator.

8. The method of claim 7, wherein
the security mode indicator indicates any one of a common mode, an authentication mode, a group key management mode, and an individual key management mode.
